(19) United States
(12) Patent Application Publication
(10) Pub. No.: US 2007/0068863 A1
(43) Pub. Date: Mar. 29, 2007

(54) Apparatus for filtering impurities of and increasing the content of negative ions in drinking water

(76) Inventors: Ko-Chien Liu, Taipei Hsien (TW); Ching-Piao Lin, Taipei Hsien (TW)

Correspondence Address: GLENN R. WILLEY, 40403 ALABAR DR., PALMDALE, CA, 93551, US

(21) Appl. No.: 11/525,776

(22) Filed: Sep. 22, 2006

Related U.S. Application Data
(60) Provisional application No. 60/721,231, filed on Sep. 28, 2005.

(51) Int. Cl. B01D 27/02

(52) U.S. Cl. 210/282

(57) ABSTRACT

The invention is an apparatus for filtering chemical, mineral and biological impurities from and increasing the content of negative ions in drinking water. It consists of an Outer and Inner cup body, with space between the Inner and Outer cup body for the function of the Passing holes mechanism. The Bottom cap of the Inner cup body includes a Holding hollow mechanism for the inclusion of a Filter pack. An Upper cap is installed at the Outside protrusion of the Neck circle, and has a Flow hole mechanism. The Flow holes align between the Outside and Inside protrusions of the Neck circle. A Switch unit controls the slide system of the Upper cap, and aligns to the Flow hole to be closed or opened.

### CROSS REFERENCE TO RELATED APPLICATIONS

This application is based on provisional application Ser. No. 60/721,231, filed on Sep. 28, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of water filtration products, and more specifically to apparatus for filtering chemical, mineral and biological impurities from drinking water and increasing the content of negative ions in drinking water.

### BRIEF SUMMARY OF THE INVENTION

The primary object of the invention is that is reduces chemical, mineral and biological impurities from drinking water.

Another object of the invention is that it increases the negative ion concentration of drinking water to help the body eliminate free radicals.

Another object of the invention is that it provides a portable source of clean drinking water, unlike traditional stationary filtering systems.

A further object of the invention is that it has a dual cup structure with isolated filter allows for filtration of contaminates of ice cubes as they melt.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed apparatus for filtering chemical, mineral and biological impurities and increasing the content of negative ions in drinking water comprising: An Outer cup body (10), A Neck circle (20) with anti-slip embossment (24) assembled at the Outer cup body (10), with Passing holes (23) between the Outside protrusion (21) and Inside protrusion (22), An Inner cup body (30) installed at the Inside protrusion (22) of Neck circle (20), with space between Inner cup body (30) and Outer cup body (10) for the function of the Passing holes mechanism (23), and the Bottom cap (40) of Inner cup body (30) has a Holding hollow mechanism (31) for the Filter pack (71), A Bottom cap (40) is installed at the bottom of Inner cup body (30) which is equipped with holes (32), locates the opening of the Inner cup body's (30) Holding hollow (31), besides, the Bottom cap (40) having anti-slip embossment (42) has a Pass through hole (41) mechanism, use the space between Holding hollow (31) and Bottom cap (40) to put Filter material (72), An Upper cap (50) with ventilated hole (53) is installed at the Outside protrusion (21) of Neck circle (20), and has a mechanism of Flow hole (51), this Flow hole aligns between the Outside protrusion (21) and Inside protrusion (22) of Neck circle (20), A Switch unit (60) consisting of Upper Seal Board (62) and Lower Seal Board (61) connected by Protrusion (611) of Lower Seal Board (61) and mating Receptacle (621) of Upper Seal Board (62) controlling the slide system through the Slide slot (52) of Upper cap (50), and when in open position, aligning the Ventilating hole (612) of the Lower Seal Board (61) with the Ventilating hole of Upper Seal Board (62) and the Ventilating hole (53) of Upper Cap (50) and causing the Flow hole (51) in Upper Cap (50) to be open to the Passing holes (23) of Neck Circle (20), and when Switch unit (60) is in closed position Ventilating hole (612) and Ventilating hole (621) are blocked as is Flow Hole (51) in Upper Cap (50).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded perspective view of the invention.

FIG. 2 is a plan view of the Neck circle.

FIG. 3 is a bottom view of the Inner cup body.

FIG. 4 is a section view of the apparatus with switch in closed position.

FIG. 5 is a section view of apparatus in process of filtering water.

FIG. 6 is a section view with water levels at equilibrium.

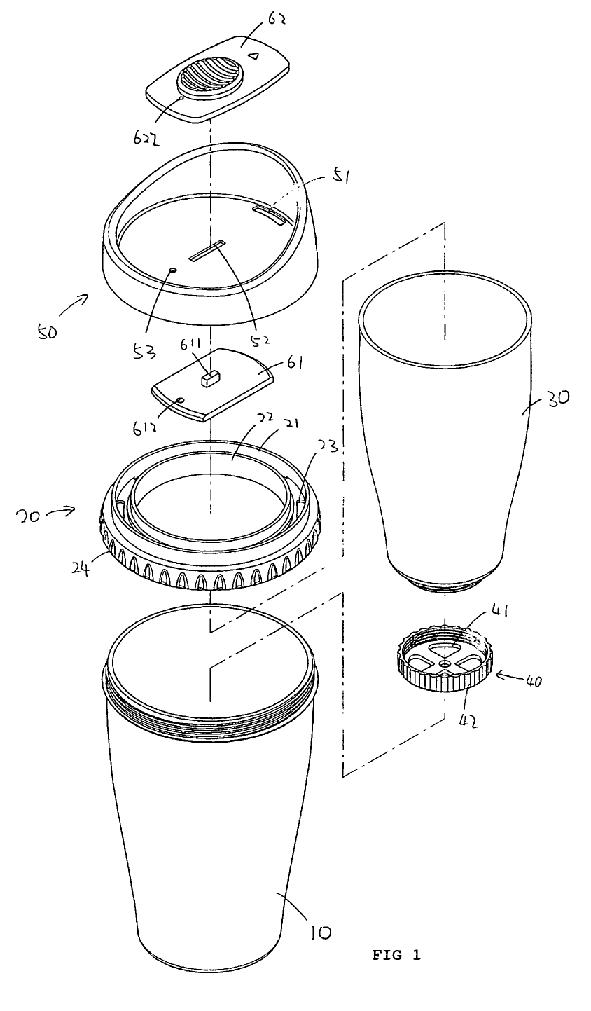

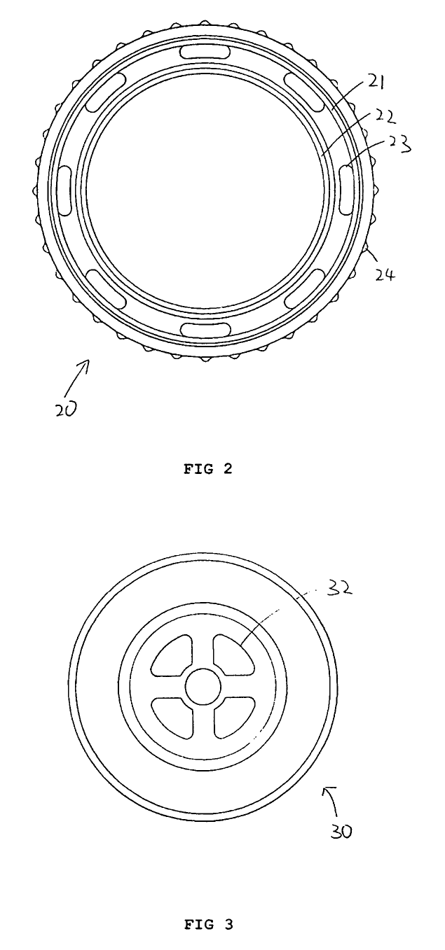

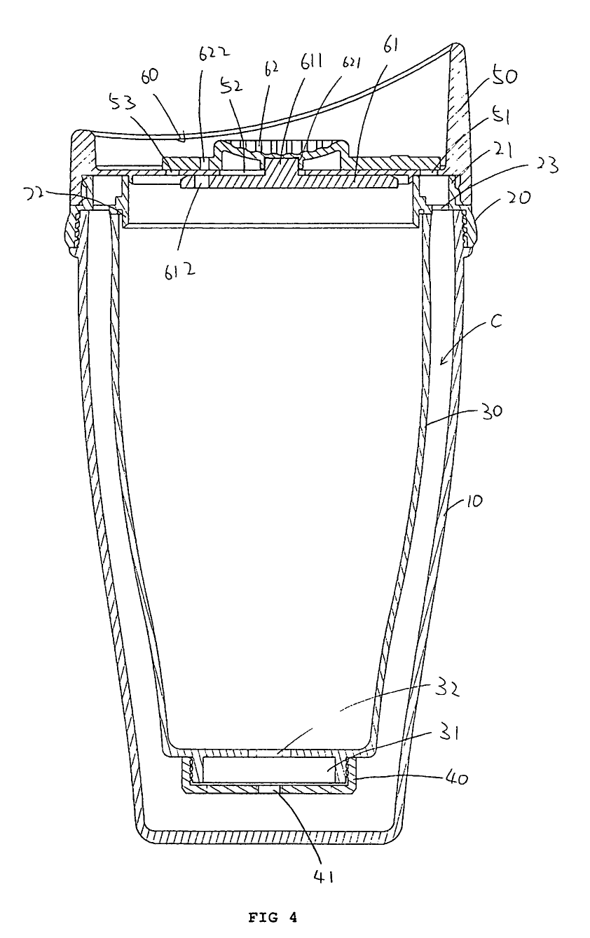

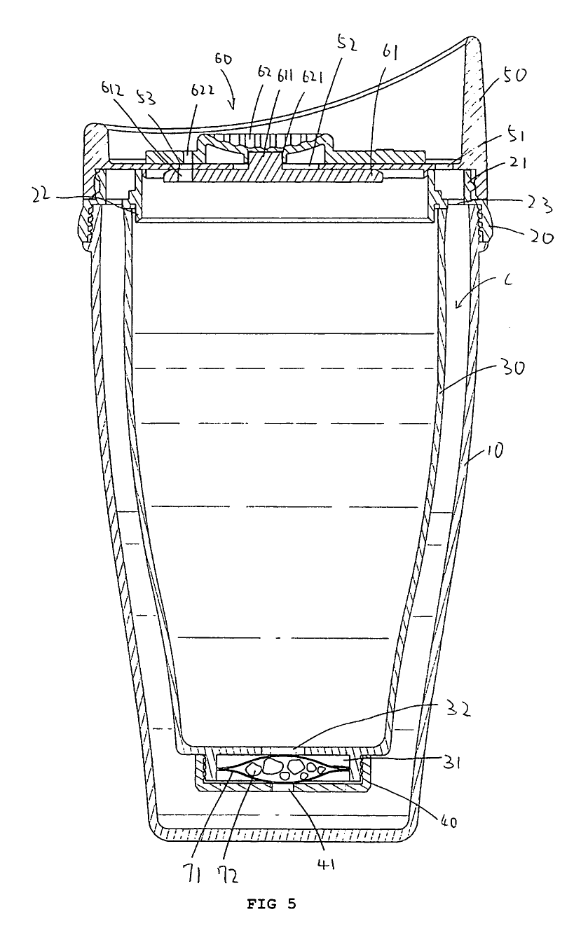

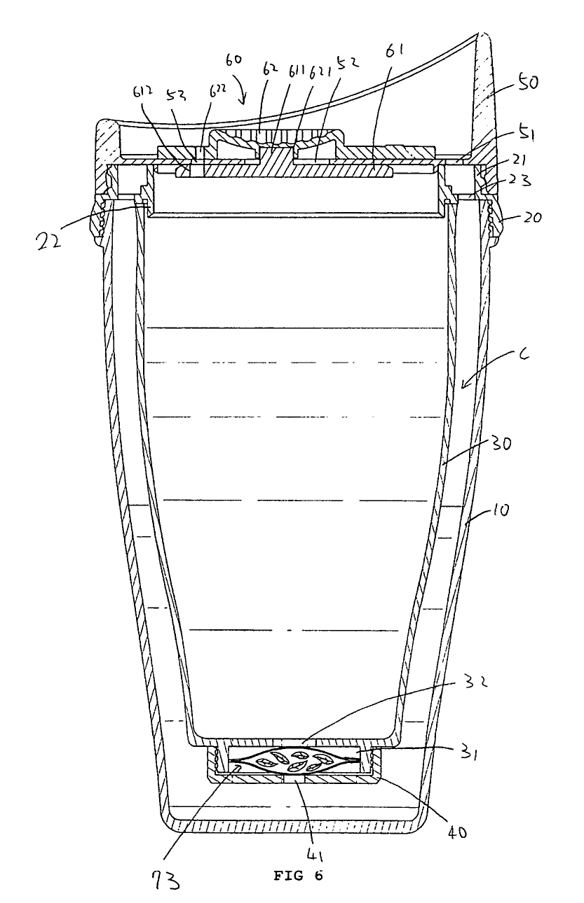

| Parts No. | Description |
|---|---|
| 10 | Outer cup body |
| 20 | Neck circle |
| 21 | Outside protrusion |
| 22 | Inside protrusion |
| 23 | Passing hole |
| 24 | Anti-slip embossment |
| 30 | Inner cup body |
| 31 | Holding hollow |
| 32 | Holes |
| 40 | Bottom cap |
| 41 | Pass through hole |
| 42 | Anti-slip embossment |
| 50 | Upper cap |
| 51 | Flow hole |
| 52 | Slide slot |
| 53 | Ventilated hole |
| 60 | Switch unit |
| 61 | Lower seal board |
| 62 | Upper seal board |
| 71 | Filter pack |
| 72 | Filter material |
| 611 | Protrusion |
| 612 | Ventilation hole |
| 621 | Receptacle |
| 622 | Ventilation hole |

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Apparatus for filtering chemical, mineral and biological impurities from drinking water and increasing the content of negative ions in drinking water comprising:
An Outer Cup Body;
A Neck Circle assembled at the Outer Cup Body, with Passing holes between the Outside protrusion and Inside protrusion;
An Inner cup body installed at the Inside protrusion of Neck circle, with space between Inner cup body and Outer cup body for the function of the Passing holes mechanism, and the Bottom cap of Inner cup body has a Holding hollow mechanism for the Filter pack;
A Bottom cap is installed at the bottom of Inner cup body, it locates the opening place of Inner cup body' Holding hollow, besides, the bottom cap has Pass through hole mechanism, use the space between Holding hollow and bottom cap to put Filter material;
An Upper cap is installed at the Outside protrusion of Neck circle, and has a mechanism of Flow hole, this Flow aligns between the Outside protrusion and Inside protrusion of Neck circle;
A Switch unit controls the slide system of Upper cap, and aligns to the Flow hole to be closed or opened.

2. Apparatus for filtering chemical, mineral and biological impurities from and increasing the content of negative ions in drinking water as claimed in claim 1 wherein said Neck circle has several Passing holes between Outside protrusion and Inside protrusion.

3. Apparatus for filtering chemical, mineral and biological impurities from and increasing the content of negative ions in drinking water as claimed in claim 1 wherein said Neck circle is patterned with Anti-slip embossment around the periphery.

4. Apparatus for filtering chemical, mineral and biological impurities from and increasing the content of negative ions in drinking water as claimed in claim 1 wherein said Bottom cap is patterned with Anti-slip embossment around the periphery.

5. Apparatus for filtering chemical, mineral and biological impurities from and increasing the content of negative ions in drinking water as claimed in claim 1 wherein said Switch unit includes a Lower seal board and Upper seal board, with the Lower seal board having a protrusion to join with the Upper seal board, which together can be used to open and close the Flow hole.

6. Apparatus for filtering chemical, mineral and biological impurities from and increasing the content of negative ions in drinking water as claimed in claim 1 wherein said Holding hollow of Inner cup body and Bottom cap is a receptacle for the Filter pack in any shape or size containing said Filter material.

7. Apparatus for filtering chemical, mineral and biological impurities from and increasing the content of negative ions in drinking water as claimed in claim 1 wherein said [Holding hollow of Inner cup body and Bottom cap is a receptacle for the Filter pack in any shape or size containing a tea or coffee pack.

8. Apparatus for filtering chemical, mineral and biological impurities from and increasing the content of negative ions in drinking water as claimed in claim 5 wherein said Lower seal board and Upper seal board incorporate a ventilating hole which corresponds to the ventilating hole of said Upper cap.

9. Apparatus for filtering chemical, mineral and biological impurities from and increasing the content of negative ions in drinking water as claimed in claim 5 wherein said Lower seal board contains a protrusion to mate with the receptacle of said Upper seal board.

10. Apparatus for filtering chemical, mineral and biological impurities from and increasing the content of negative ions in drinking water as claimed in claim 6 wherein said Filter pack is encased in non-woven cloth, hollow silk cotton, other thin porous membrane.

11. Apparatus for filtering chemical, mineral and biological impurities from and increasing the content of negative ions in drinking water as claimed in claim 6 wherein said Filter pack may contain far infrared ray porcelain materials, tourmaline crystals, or any active carbon filter material.
